(19) United States
(12) Patent Application Publication
(10) Pub. No.: US 2009/0078097 A1
(43) Pub. Date: Mar. 26, 2009

(54) Foam grooving sled has a built-in straight edge guide and a fixed margin from the left side edge of the grooving sled to the groove cutting position

(76) Inventor: Tina V. Truong, Mississauga, CA (US)

Correspondence Address: Tina Truong, 1697 Westbridge Way, Mississauga, ON, L5N 7S7, CA

(21) Appl. No.: 11/859,798

(22) Filed: Sep. 24, 2007

(51) Int. Cl. B26D 7/06

(52) U.S. Cl. 83/109

(57) ABSTRACT

A foam grooving sled has a built-in straight edge guide which comes with a stabilizer plate that fit inside the cutting groove to keep the grooving sled straight while slide along the groove layout line on the wall. The stabilizer plate is adjustable between 90 to 45 degree angles. It has a fixed margin from the left side edge of the grooving sled to the groove cutting line for easily layout the groove position on a wall.

### BACKGROUND OF THE INVENTION

This invention relates to a grooving sled holding a preformed blade which is attached to a hot knife that melt strips of Expanded Polystyrene (EPS) foam board to produce an aesthetical pleasing appearance rather than having a flat, blank finishing of the foam exterior insulation walls. Groove shapes such as Square, Round or U, bevel, angle and V are commonly used to achieve different effects to enhancing the exterior appearance of a building.

The operator should begin by laying out the groove positions on a wall with snapped chalk lines. These lines can be determined by measuring the distant between the edge of the grooving sled to the groove cutting line. Add or subtract this distant to the actual groove position and snap the line for grooving.

Conventional grooving sleds have adjustable blade holders on both sides of the sled. This will result in different measurements for the distant from the edge of the grooving sled to the groove cutting line. Therefore, every time the grooving blade changes, the operator will need to measure the distant between to the edge of the grooving sled to the groove cutting line.

The conventional grooving sleds will need a wood or steel stud to act as a straight edge guide, by placing the stud closely to the snapped line and slide the grooving sled along the straight edge guide to melt strips of EPS foam board to create a controlled groove. While performing this procedure, the operator needs to use both hands, one hand holding the stud and other hand holding the grooving sled. At the same time the operator will need to move along the wall follow the layout line.

### BRIEF SUMMARY OF THE INVENTION

This invention relates to an improved foam grooving sled that has a built-in straight edge guide to give the operator a free hand eliminating the need to use a wood or steel stud to act as a straight edge guide.

This foam grooving sled also has a fixed blade holder position on the left side to provide a fixed margin from the edge of the grooving sled to the groove cutting line. Thus, it will eliminate the need to measure the left margin every time the grooving blade changes.

### BRIEF DESCRIPTION OF THE DRAWINGS

FIG. 1 is a drawing of the foam grooving sled that has a built-in straight edge guide with a stabilizer plate that fit inside the groove, a fixed grooving blade holder on left side and an adjustable grooving blade holder on right side.

FIG. 2 is a drawing of the straight edge guide and the stabilizer plate.

FIG. 3 is a drawing of the stabilizer plate at a 45 degree angle.

FIG. 4 is a drawing of the angle adjuster.

FIG. 5 is a drawing of the grooving sled position for straight angle grooves.

FIG. 6 is a drawing of the grooving sled position for bevel or V grooves.

FIG. 7 is a drawing of an optional grooving sled position for straight angle grooves having width greater than ¾.

### DETAIL DESCRIPTION OF THE INVENTION

FIG. 1 illustrates a foam grooving sled which has a build-in straight edge guide of a 90 degree right angle to act as a straight edge guide to follow the groove layout line on the wall. It also has a stabilizer plate that fit inside the newly cut groove line with the foam strip still attach to the uncut section of the wall. The stabilizer plate will keep the grooving sled from moving left or right while the operator slides along the grooving line. The stabilizer plate is adjustable between 90 to 45 degree angles.

The grooving sled also has a fixed grooving blade holder on the left side and an adjustable grooving blade holder on the right side. The left side fixed grooving blade holder has a margin of 1″ from the left side edge of the grooving sled to the groove cutting line. There is an option of having a margin of ½″ for cutting straight angle grooves having width greater than ¾″ by switching the fixed blade holder around.

By having a fixed margin of ½″ and 1″ from the left side edge of the grooving sled to the groove cutting line will greatly assists the operator when calculating the layout of groove position on the wall.

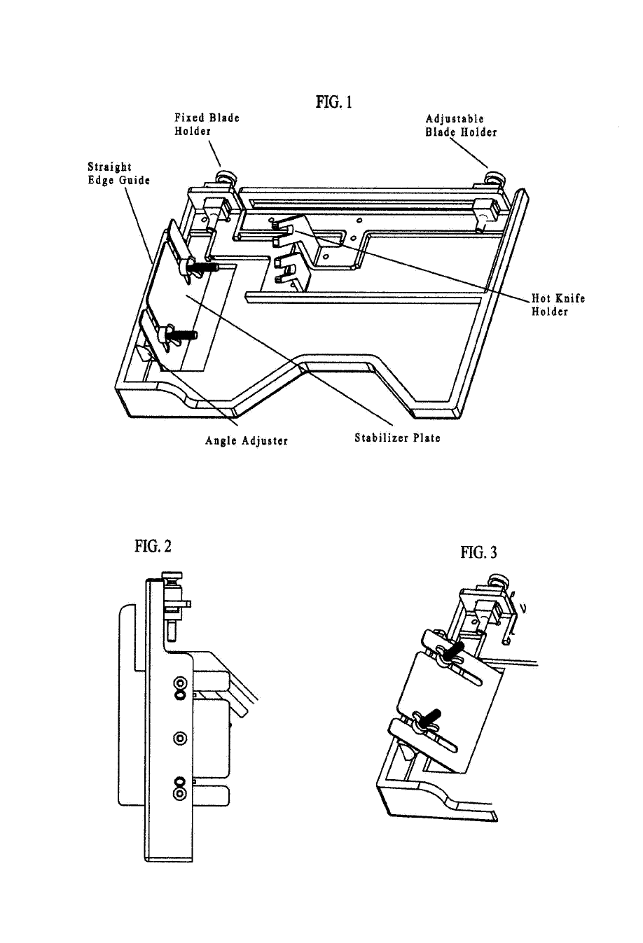

FIG. 2 illustrates the stabilizer plate extends below the bottom of the grooving sled to go inside the groove to keep the straight edge guide securely in place, preventing the grooving sled from moving left or right while the operator follows the straight grooving line on the wall.

The stabilizer plate has an extension toward the bottom front of the sled to guide the stabilizer plate smoothly into the cutting groove.

FIG. 3 illustrates the stabilizer plate at 45 degree angle. The stabilizer plate is adjustable between 90 to 45 degree angle to line up with the cutting groove angle, so that the stabilizer plate can follow the newly cut groove to keep the grooving sled straight.

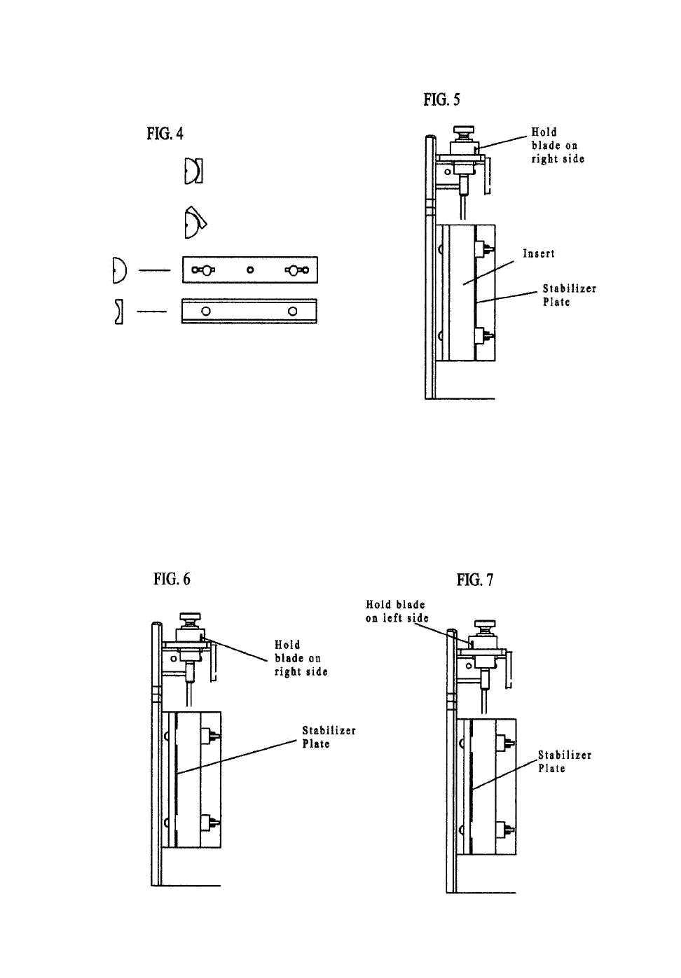

FIG. 4 illustrates the angle adjuster function by having a half circle bar mounted on the side of the straight edge guide and a rectangle bar having an inward radius placed between the half circle bar and the stabilizer plate and tighten together with pivoting bolts and wing nuts. When moving the pivoting bolts, the rectangle inward radius bar will move up or down, and at the same time tilt the stabilizer plate to an angle lining up with the cutting groove angle, so the stabilizer plate can slide inside the cutting groove.

FIG. 5 illustrates a straight angle (square, round or U) blade position that has 1″ left margin. The groove cutting blade is on the right side of the holder and the stabilizer plate is on right side of the insert.

Insert is a rectangle bar which allows the stabilizer plate to line up with the straight angle groove cutting line.

FIG. 6 illustrates a bevel or V grooving blade position that has 1″ left margin. The groove cutting blade is on the right side of the holder and the stabilizer plate is on left side of the insert.

FIG. 7 illustrates an optional position that has ½″ left margin for cutting straight angle grooves of ¾″ or greater width. The groove cutting blade is on the left side of the holder and the stabilizer plate is on left side of the insert.

I claim:

1. A foam grooving sled comprising:
a fixed blade holder on the left side of the grooving sled to provide a fixed margin from the left side edge of the grooving sled to the groove cutting line;
a 90 degree right angle on left side of the grooving sled to act as a straight edge guide; and
a stabilizer to support the straight edge guide which is adjustable between 90 to 45 degree angles.

2. A grooving sled according to claim 1, wherein said a stabilizer has a plate which attach to an angle adjuster, extends below the bottom and all the way toward the front of the grooving sled allowing the stabilizer plate to fit inside the groove smoothly.

3. A grooving sled according to claim 2, wherein said an angle adjuster has a half circle bar and an inward radius rectangular bar, mounted together with the insert and the plate to provide adjustable angles for the stabilizer by moving the pivoting bolts.

4. A grooving sled according to claim 3, wherein said an insert is a rectangle bar to keep the stabilizer plate lined up with the straight angle groove cutting line.
